(19) United States
(12) Patent Application Publication
(10) Pub. No.: US 2004/0017534 A1
(43) Pub. Date: Jan. 29, 2004

(54) Liquid crystal display device having controlled gap between substrates

(75) Inventors: Yasuhiro Miki, Fukushima-ken (JP); Yoshifumi Masumoto, Fukushima-ken (JP)

Correspondence Address: Brinks Hofer Gilson & Lione, P.O. Box 10395, Chicago, IL, 60610, US

(73) Assignee: ALPS Electric Co., Ltd.

(21) Appl. No.: 10/617,328

(22) Filed: Jul. 10, 2003

(30) Foreign Application Priority Data
Jul. 24, 2002 (JP) 2002-215698

(51) Int. Cl. G02F 1/1343

(52) U.S. Cl. 349/143

(57) ABSTRACT

A liquid crystal display device includes a pair of substrates opposing each other with a gap therebetween, a liquid crystal layer held between the pair of substrates, transparent electrodes provided on the liquid crystal layer side of each of the pair of substrates so that the transparent electrodes on one of the substrates intersect the transparent electrodes on the other substrate, lead wirings provided on one of the substrates to be connected to the transparent electrodes on the one substrate so that ends of the transparent electrodes on the one substrate are overlapped on the lead wirings to form overlap portions, and a transparent dummy electrode provided for controlling the gap at a position on the other substrate opposite to a connection portion between the transparent electrodes and the lead wirings on the one substrate. The transparent dummy electrode is formed to avoid positions opposite to the overlap portions.

### BACKGROUND OF THE INVENTION

1. Field of the Invention

The present invention relates to a liquid crystal display device, and particularly to a technique for controlling gaps between substrates near ends of transparent electrodes.

2. Description of the Related Art

In a STN (Super-Twisted Nematic) liquid crystal display device, two driving ICs have recently been combined into one for complying with miniaturization and cost reduction of an electronic apparatus. Namely, two driving ICs conventionally connected to common-side transparent electrodes and segment-side transparent electrodes, respectively, are gathered on one side of a panel so that the two driving ICs are replaced by one driving IC for driving.

Such a liquid crystal display device is realized by, for example, providing metal lead wirings on one of a pair of substrates which oppose each other with a predetermined gap (liquid crystal cell gap) therebetween, a liquid crystal layer being provided between the substrates. Also, some of the lead wirings are connected to ends of segment-side transparent electrodes, and the other lead wirings are extended from one of the substrates to the other substrate through a conductive sealing resin and connected to common-side transparent electrodes, the lead wirings being connected to a driving IC.

The gap is determined by the distance between alignment films formed on the segment-side and common-side transparent electrodes, for orienting the liquid crystal molecules of the liquid crystal layer. In a normal liquid crystal display device, the gap is set to about 4 to 6 μm. In the STN-type liquid crystal display device, the gap must be controlled with a precision of about ±10 nm because a variation in the gap significantly influences the occurrence of display nonuniformity.

The gap must be precisely controlled not only in a display region of the liquid crystal display device but also in a peripheral region such as a region near ends of the transparent electrodes. Therefore, in a conventional liquid crystal display device, a transparent dummy electrode is provided on the other substrate opposite to ends of transparent electrodes so that the gaps at the ends coincide with the gap of the display region.

However, in the liquid crystal display device having the above-described construction, ends of the segment-side transparent electrodes are overlapped on the lead wirings in order to securely connect the lead wirings and the segment-side transparent electrodes. Therefore, the gaps at the ends are smaller than the gaps in the other portions of the transparent electrodes. This state is shown in FIG. 7. FIG. 7 is a schematic sectional view of the vicinity of ends of segment-side transparent electrodes of a conventional liquid crystal display device. In FIG. 7, reference numeral 130 denotes a liquid crystal layer, reference numeral 106 denotes a lead wiring extending perpendicularly to the drawing of FIG. 7, reference numeral 115a an end of a segment-side transparent electrode 115 overlapped on the lead wiring 106, reference numeral 114 denotes an alignment film including a planarizing film, reference numeral 110 denotes a substrate, reference numeral 145 denotes a transparent dummy electrode provided for controlling a gap, reference numeral 126 denotes an alignment film, and reference numeral 120 denotes another substrate. The transparent dummy electrode 145 is formed in substantially parallel to common-side transparent electrodes to have substantially the same shape as that of the common-side transparent electrodes, which are schematically shown in the drawing, except that it is not connected to the lead wirings. The transparent dummy electrode 145 intersects the segment-side transparent electrodes 115.

The thickness of each of the above component members will be described by example. The thickness of each segment-side transparent electrode 115 is about 0.23 μm, and the thickness of each lead wiring 106 is about 0.1 μm to 0.3 μm. Therefore, the thickness of each of the overlap portions between the lead wirings 106 and the ends 105a is 0.33 μm to 0.53 μm, and thus the ends 115a project toward the liquid crystal layer 130.

Therefore, the gap de at the end 115a of each segment-side transparent electrode 115 is smaller than the gap do in another portion by an amount corresponding to the thickness (about 100 to 300 nm) of the lead wirings 106, the amount being larger than the gap precision (±10 nm).

Therefore, particularly in the STN-type liquid crystal display device, a decrease in the gap precision in the peripheral region influences the display region to possibly produce display unevenness in the display region.

### SUMMARY OF THE INVENTION

Accordingly, the present invention has been achieved in consideration of the situation, and it is an object of the present invention to provide a liquid crystal display device without display unevenness.

In order to achieve the object, the present invention has the construction below.

A liquid crystal display device of the present invention comprises a pair of substrates opposing each other with a gap therebetween, a liquid crystal layer held between the pair of substrates, transparent electrodes provided on the liquid crystal layer side of each of the pair of substrates so that the transparent electrodes on one of the substrates intersect the transparent electrodes on the other substrate, metal lead wirings provided on one of the substrates to be connected to the transparent electrodes on the one substrate so that ends of the transparent electrodes on the one substrate are overlapped on the lead wirings to form overlap portions, a transparent dummy electrode provided for controlling the gap on a portion of the other substrate opposite to the connections between the transparent electrodes and the lead wirings on the one substrate, wherein the transparent dummy electrode is formed to avoid positions opposite to the overlap portions.

In the liquid crystal display device, the transparent dummy electrode is provided for controlling the gap to avoid the positions opposite to the overlap portions, and thus the gap in each overlap portions can be set to substantially the same as the gaps in the other portions, thereby preventing the occurrence of display unevenness in the liquid crystal display device.

The liquid crystal display device of the present invention is characterized in that the transparent dummy electrode is also provided on portions opposite to the spaces between the ends of the transparent electrodes on the one substrate.

In the liquid crystal display device, the transparent dummy electrode is also provided on the portions opposite to the spaces between the ends of the transparent electrodes on the one substrate, and thus the gaps in the spaces between the ends can be set to substantially the same as the gaps in the other portions, thereby preventing the occurrence of display unevenness in the liquid crystal display device.

In the above-described liquid crystal display device of the present invention, the transparent electrodes on the one substrate are preferably set to be wider than the lead wirings.

### BRIEF DESCRIPTION OF THE DRAWINGS

FIG. 1 is an exploded perspective view showing a liquid crystal display device according to an embodiment of the present invention;

FIG. 2 is a schematic view showing a partial sectional structure including an end of the liquid crystal display device of the embodiment shown in FIG. 1;

FIG. 3 is a plan view of a substrate constituting the liquid crystal display device shown in FIG. 1;

FIG. 4 is a plan view of another substrate constituting the liquid crystal display device shown in FIG. 1;

FIG. 5 is a plan view showing the connections between transparent electrodes and lead wirings on a substrate, as viewed from another substrate;

FIG. 6 is a sectional view taken along line VI-VI in FIG. 5; and

FIG. 7 is a sectional view showing a principal portion of a conventional liquid crystal display device.

### DESCRIPTION OF THE PREFERRED EMBODIMENTS

An embodiment of the present invention will be described below with reference to the drawings.

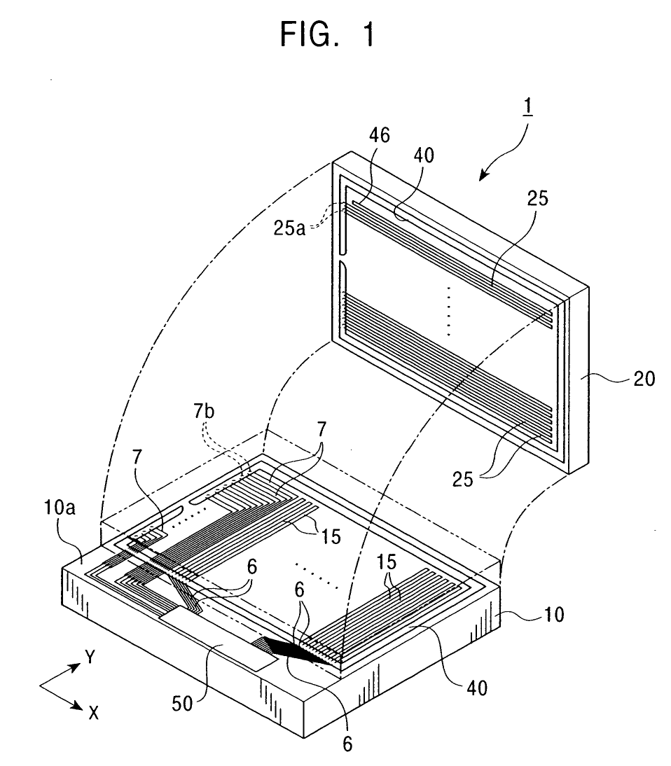

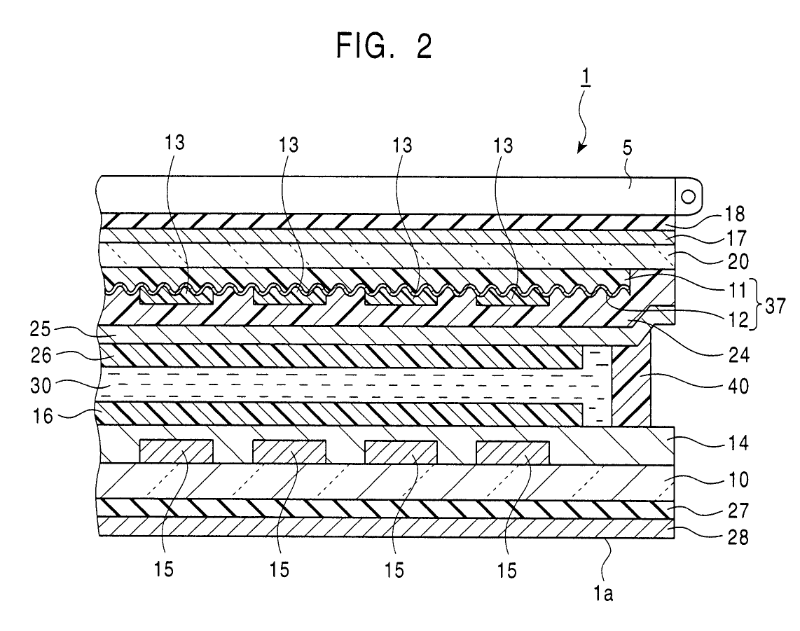

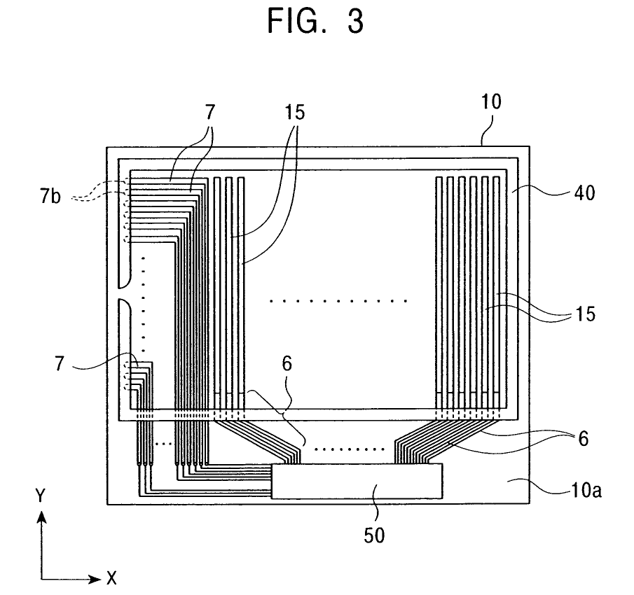

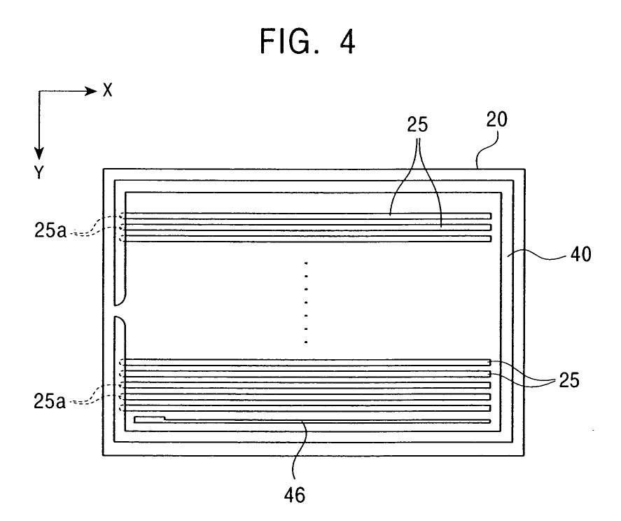

FIG. 1 is an exploded perspective view of a simple matrix liquid crystal display device according to an embodiment of the present invention, and FIG. 2 is a schematic view showing a partial sectional structure including an end of the liquid crystal display device of this embodiment. FIG. 3 is a plan view of a substrate constituting the liquid crystal display device, and FIG. 4 is a plan view of another substrate constituting the liquid crystal display device shown in FIG. 1.

As shown in FIGS. 1 to 4, the liquid crystal display device 1 of this embodiment comprises a first substrate (a substrate) 10 and a second substrate (another substrate) 20 which oppose each other with a predetermined gap therebetween, and a liquid crystal layer 30 held between the substrates 10 and 20. Also, pluralities of transparent electrodes 15 and 25 are provided on the liquid crystal layer sides of the first and second substrates 10 and 20, respectively. Furthermore, a transparent dummy electrode 46 is provided in substantially parallel to the transparent electrodes 25 on the second substrate 2.

Furthermore, a resin (anisotropic conductive resin) 40 containing conductive particles is formed in a ring shape between the first and second substrates 10 and 20 so that the liquid crystal layer 30 is disposed inside the anisotropic conductive resin 40 and held between the substrates 10 and 20.

As shown in FIGS. 1 and 2, the transparent electrodes 15 (the transparent electrodes on a substrate) extending in the Y direction shown in the drawings for driving the liquid crystal layer 30, a planarizing overcoat film 14, and an alignment film 16 for controlling the orientation of the liquid crystal molecules, which constitute the liquid crystal layer 30, are formed in order on the liquid crystal layer side of the first substrate 10 (a substrate). On the other hand, a reflector 37, a color filter 13 for a color display, an overcoat film 24 for protecting the reflector 37 and planarizing irregularities formed by the reflector 37 and the color filter 13, the transparent electrodes 25 (the transparent electrodes on another substrate) extending in the X direction shown in the drawings for driving the liquid crystal layer 30, and an alignment film 26 for controlling the orientation of the liquid crystal molecules, which constitute the liquid crystal layer 30, are formed in order on the liquid crystal layer side of the second substrate 20 (another substrate).

The reflector 37 comprises an organic film 11 and a metal reflective film 12 formed on the organic film 11.

Furthermore, a retardation plate 17 and a polarizing plate 18 are provided on the side of the second substrate 20 apart from the liquid crystal layer 30, and a retardation plate 27 and a polarizing plate 28 are provided on the side of the first substrate 10 apart from the liquid crystal layer 30. The outer surface of the polarizing plate 28 is a display surface 1a. Also, a back light 5 is disposed as a light source on the outside of the polarizing plate 18, for performing a transmissive display in the liquid crystal display device 1.

Each of the transparent electrodes 15 and 25 comprises a transparent conductive film of ITO (Indium Tin Oxide) or the like and has a rectangular planar shape, and the transparent electrodes 15 and 25 are formed in lines and connected to a driving IC 50 for driving the liquid crystal molecules constituting the liquid crystal layer 30. The liquid crystal display device 1 is a passive matrix type in which transparent electrodes 15 are disposed perpendicularly to the transparent electrodes 25 in a plan view.

As shown in FIG. 1, the length of the second substrate 20 in the width direction (the X direction shown in the drawing) is equal to the length of the first substrate 10 in the width direction (the X direction), and the length of the second substrate 20 in the longitudinal direction (the Y direction shown in the drawing) is smaller than the length of the first substrate 10 in the longitudinal direction (the Y direction). Therefore, when the substrates 10 and 20 are combined together, a portion (terminal portion) 10a of the liquid crystal layer side of the first substrate 10 is exposed. The driving IC 50 is mounted to the terminal portion 10a.

As shown in FIGS. 1 and 3, metal lead wirings 6 are formed on the first substrate 10, for leading the transparent electrodes 15 to the terminal portion 10a. The lead wirings 6 have ends connected to the respective transparent electrodes 15, and the other ends are connected to the driving IC 50. Each of the lead wirings 16 comprises a metal material such as Cr, Al, or the like.

As shown in FIGS. 1 and 4, the transparent electrodes 25 are formed on the second substrate 20 to extend in the X direction. The transparent electrodes 25 have ends 25a extending to the anisotropic conductive resin 40 outside a region where the alignment film 26 is formed. As shown in FIG. 3, other metal lead wirings 7 are formed on the first substrate 10. Each of the lead wirings 7 comprises a metal material such as Cr, Al, or the like, and ends of the lead wirings 7 are connected to the driving IC 50. The lead wirings 7 extend substantially in the Y direction within the region (display region) surrounded by the anisotropic conductive resin 40, and are bent to the direction opposite to the X direction at intermediate positions. The ends (the other ends 7b) of the lead wirings 7 cross the anisotropic conductive resin 40. The first and second substrates 10 and 20 are bonded together with the liquid crystal layer 30 held therebetween so that the ends 25a of the transparent electrodes 25 are overlapped with the other ends 7b of the lead wirings 7.

Therefore, when the first and second substrates 10 and 20 are bonded together, the ends 25a of the transparent electrodes 25 are electrically connected to the other ends 7b of the lead wirings 7 through the anisotropic conductive resin 40. The anisotropic conductive resin 40 comprises a binder resin and conductive particles of a metal or the like so that the conductive particles in the resin are held between the ends 25a and the other ends 7b to electrically connect the transparent electrodes 25 and the lead wirings 7 when the substrates 10 and 20 are bonded together.

In this way, the transparent electrodes 25 on the second substrate 20 are connected to the lead wirings 7 on the first substrate 1 through the anisotropic conductive resin 40 to permit the transparent electrodes 25 to be led to one side of the first substrate 10 through the lead wirings 7. Therefore, only the driving IC 50 may be provided.

As shown in FIGS. 1 and 4, the transparent dummy electrode 46 is formed on the second substrate 20 to extend along the Y direction. Like the transparent electrodes 25, the transparent dummy electrode 46 comprises ITO, and is formed in substantially parallel to the transparent electrodes 25 to have substantially the same thickness as the transparent electrodes 25. The transparent dummy electrode 46 is formed inside the anisotropic conductive resin 40 without having contact with anisotropic conductive resin 40. Therefore, the transparent dummy electrode 46 is electrically insulated.

As shown in FIGS. 1, 3 and 4, the transparent dummy electrode 46 is formed at a position which faces the connection portion between the transparent electrodes 15 and the lead wirings 6 on the first substrate 10 when the substrates 10 and 20 are bonded together.

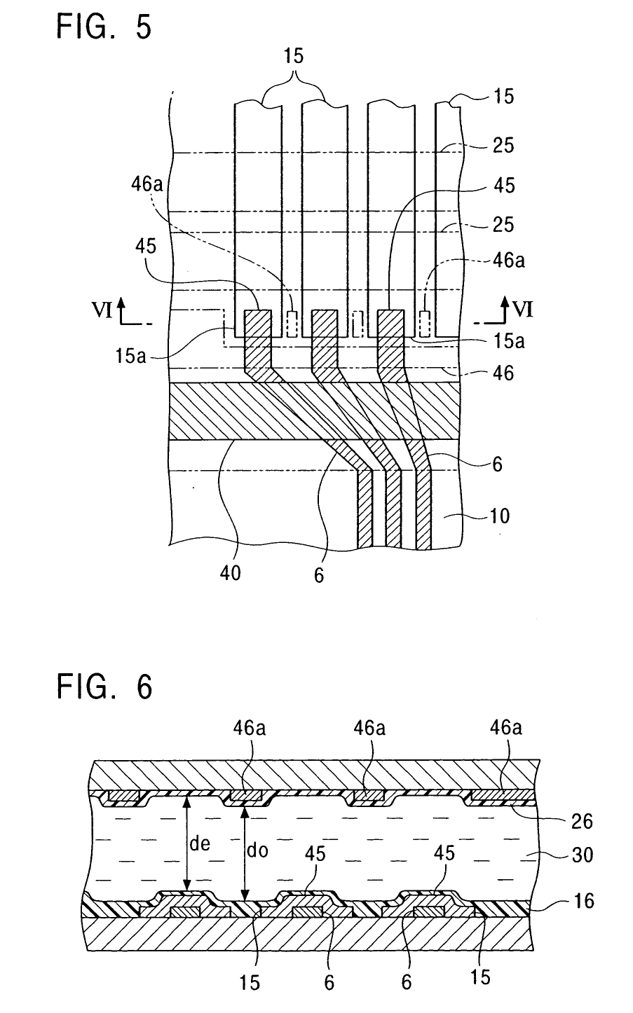

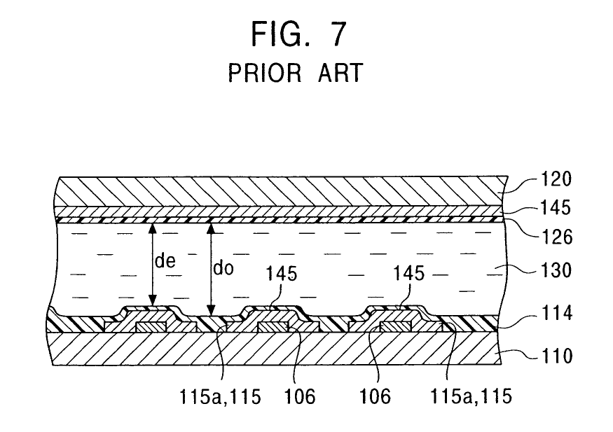

FIG. 5 shows a principal portion of the liquid crystal display device 1. FIG. 5 is a plan view showing the connection portion between the transparent electrodes 15 and the lead wirings 6, as viewed from the second substrate 20. FIG. 6 is a sectional view taken along line VI-VI in FIG. 5.

Since FIG. 5 is a plan view from the second substrate 20, the transparent electrodes 25 and the transparent dummy electrode 46 on the second substrate 20 are shown by two-dot chain lines.

As shown in FIG. 5, the lead wirings 6 are connected to the respective transparent electrodes 15. The transparent electrodes 15 are wider than the lead wirings 6, and the ends 15a are overlapped on the respective lead wirings 6 to form overlap portions 45.

The thickness of each overlap portion 45 is equal to the total thickness of the transparent electrode 15 and the lead wiring 6. For example, when the thickness of each transparent electrode 15 is about 0.18 to 0.28 μm, and the thickness of each lead wiring 6 is about 0.1 to 0.3 μm, the thickness of each overlap portion 45 is about 0.28 to 0.58 μm.

As shown in FIG. 5, the transparent dummy electrode 46 is formed to avoid positions opposite to the overlap portions 45 on the first substrate 10. Namely, the transparent dummy electrode 46 is formed with substantially the same width as the transparent electrodes 25 in a region (on the left side of FIG. 5) in which the transparent electrodes 15 are not formed, and with a width smaller than that of the transparent electrodes 25 in a region (from the center to the right side of FIG. 5) in which the transparent electrodes 15 are formed. Therefore, in the region where the transparent electrodes 15 are formed, the transparent dummy electrode 46 crosses only the lead wirings 6 without crossing the transparent electrodes 15. As shown in FIGS. 5 and 6, island-like portions 46a of the transparent dummy electrode are provided on the second substrate 20. The island-like portions 46a of the transparent dummy electrode are disposed in regions opposite to the spaces between the ends 15a of the transparent electrodes 15, and the thickness of each island-like portion 46a is about 0.18 to 0.28 μm.

In the above-described construction, as shown in FIG. 6, the gap de in each overlap portion 45 is substantially the same as the gap do in each of the spaces between the respective transparent electrodes 15.

Namely, the transparent dummy electrode 46 including the island-like portions 46a is formed to avoid the overlap portions 45 to cause irregularities on the surface of the alignment film 26 on the second substrate 20, and the overlap portions 45 projecting to the liquid crystal layer 30 cause irregularities on the surface of the alignment film 16 on the first substrate 10. However, the irregularities on the alignment film 16 engage with the irregularities on the alignment film 26 along the line VI-VI in FIG. 5 so that the gaps de and d0 between the alignment films 16 and 26 become substantially constant.

Therefore, the gaps near the ends 15a of the transparent electrodes 15 become substantially constant, and are substantially the same as the gap in the display region, thereby preventing the occurrence of display unevenness in the display region.

In the above-described liquid crystal display device, the metal lead wirings 6 are narrower than the transparent electrodes 15 comprising ITO, and thus the lead wirings 6 are completely covered with the ends 15a in the respective overlap portions 45. Therefore, an etching solution used for forming the transparent electrodes 15 do not enter into the overlap portions 45, thereby securely connecting the transparent electrodes 15 and the lead wirings 6 in the respective overlap portions 45.

In this embodiment, the island-like portions 46a of the transparent dummy electrode may be omitted. In this case, the gaps near the ends 15a of the transparent electrodes 15 slightly vary, but the gaps can be set to substantially the same as the gap in the display region, thereby preventing the occurrence of display unevenness in the display region.

As described above, a liquid crystal display device of the present invention comprises a transparent dummy electrode which is formed to avoid positions opposite to the overlap portions, for controlling a gap. Therefore, the gaps in the overlap portions can be set to substantially the same as the gaps in the other portions, thereby preventing the occurrence of display unevenness in the liquid crystal display device.

What is claimed is:

1. A liquid crystal display device comprising:
a pair of substrates opposing each other with a gap therebetween, a liquid crystal layer being held between the pair of substrates;
transparent electrodes provided on the liquid crystal layer side of each of the pair of substrates so that the transparent electrodes on one of the substrates intersect the transparent electrodes on the other substrate;
metal lead wirings provided on one of the substrates to be connected to the transparent electrodes on the one substrate so that ends of the transparent electrodes on the one substrate are overlapped on the lead wirings to form overlap portions; and
a transparent dummy electrode provided for controlling the gap at a position on the other substrate opposite to a connection portion between the transparent electrodes and the lead wirings on the one substrate;
wherein the transparent dummy electrode is formed to avoid positions opposite to the overlap portions.

2. A liquid crystal display device according to claim 1, wherein the transparent dummy electrode is also provided on portions opposite to the spaces between the ends of the transparent electrodes on the one substrate.

3. A liquid crystal display device according to claim 1, wherein the transparent electrodes on the one substrate are wider than the lead wirings.
